(19) United States
(12) Patent Application Publication
(10) Pub. No.: US 2006/0076899 A1
(43) Pub. Date: Apr. 13, 2006

(54) Emergency lighting system

(76) Inventors: Israel Baumberg, Maaleh Adumim (IL); Oleg Berezin, Maaleh Adumim (IL); Boris Gorelik, Zur-Hadassa (IL); Netta Kerem, Beit Aryeh (IL); Moshe Voskoboinik, Maale Adumim (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/961,072

(22) Filed: Oct. 12, 2004

(51) Int. Cl. H05B 41/36

(52) U.S. Cl. 315/209 R; 315/224; 315/219

(57) ABSTRACT

An emergency lighting system, providing for transmitting communication signals over an electroluminescent filament including a communication signal input device and a communication signal receiving device connected to such electroluminescent filament. An emergency lighting system, providing for stopping voltage over an electroluminescent filament upon a break in such electroluminescent filament.

### BACKGROUND OF THE INVENTION

Electroluminescent light sources, also known as EL wires, EL cables, EL filaments, etc. are known. Such products may in some embodiments include a driver that may generate for example an alternating current of a designated amplitude and frequency. Some of such constructions are described in U.S. Pat. No. 3,069,579, U.S. Pat. No. 5,485,355, U.S. Pat. No. 5,869,930, U.S. Pat. No. 5,876,863, and U.S. Pat. No. 5,959,402, in patent publication US20040022053, and in foreign patent DE3742412.

In cases of emergency, for example, industrial or road accidents, terrorist acts or natural hazards, such an EL light source may be used, for example, for illuminating the contours of dangerous zones or marking-out passages or routes for evacuation of victims, However, sparking in case of a break in a light source is a risk. Similarly, the described constructions do not provide for communication by way of or along the EL light source.

### SUMMARY OF THE INVENTION

In accordance with an embodiment of the present invention, there is provided an emergency lighting device, method and system that includes an electroluminescent filament having at least a wire and a communication signal input device to transmit an electrical communication signal on such wire. In some embodiments a buzzer or a loudspeaker may be included in such device or system. In some embodiments the communication signal input device may include an electrical switch. In some embodiments the communication signal receiving devices may provide two-way communication along such wire.

In accordance with an embodiment of the present invention, there is provided an emergency lighting device, method and system that includes an electroluminescent filament, a voltage source and a switch to stop voltage over such electroluminescent filament in the event of a break in such electroluminescent filament. In some embodiments, a two input logic circuit is operably connected to such switch such that a first of such two inputs includes a voltage supply to such electroluminescent filament, and a second of such two inputs includes a grounded wire, such that upon such break in such grounded wire, such voltage supply to such electroluminescent filament stops.

In accordance with an embodiment of the invention, a method may include transmitting voltage to an electroluminescent filament and stopping voltage through such electroluminescent filament in the event of a break in such electroluminescent filament. In some embodiments, the method may include transmitting such voltage through a two input logic circuit, a first of such two inputs including a voltage supply, and a second of such two inputs including a grounded wire.

### BRIEF DESCRIPTION OF THE DRAWINGS

Embodiments of the invention will be understood and appreciated more fully from the following detailed description taken in conjunction with the drawings in which:

FIG. 1 is a schematic diagram of an EL lighting system in accordance with an exemplary embodiment of the invention;

FIG. 2 is a cross-section of an EL filament with a cylindrical central electrode in accordance with an embodiment of the invention;

FIG. 3 is a schematic electrical diagram of end units connected by way of a two input logic unit to an EL filament in accordance with an embodiment of the invention;

FIG. 4 is a schematic electrical diagram of end units connected to an EL filament by way of a one input logic unit in accordance with an embodiment of the invention; and

FIG. 5 is a flow diagram of a method in accordance with an embodiment of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention. Various examples are given throughout this description. These are merely descriptions of specific embodiments of the invention. The scope of the invention is not limited to the examples given.

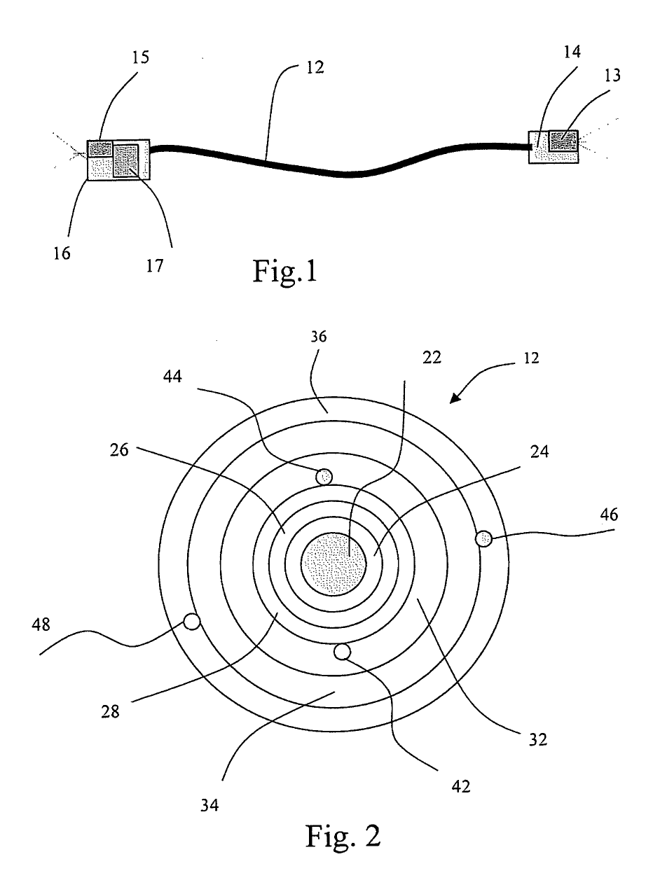

Reference is made to FIG. 1, a schematic diagram of an EL lighting system 10 in accordance with an exemplary embodiment of the invention. In some embodiments, EL filament 12 may be electrically and/or mechanically connected on an end to electrical or electronic unit 14 and on another end to electrical or electronic unit 16. Other attachments may be made, and EL lighting system 10 may include numerous branches or ends and electronic units. One or more of electronic unit 14 and electronic unit 16 may include for example a buzzer or other electrical communication signal receiving device 13 and 15 such as a loudspeaker, alarm, warning light, intercom etc., and switches (not shown in the figure) connected in such a way that for example a switch in or connected to electronic unit 14 may activate for example communication signal receiving device 15, and a switch in or connected to electronic unit 16 may activate for example communication signal receiving device 13. Other placements of switches may be used, and other activating mechanisms of for example communication signal receiving device 13 may be used. In some embodiments a communication signal receiving device may be, for example, a loudspeaker such as a detachable loudspeaker located along the path of EL filament 12. In some embodiments, a switch may be or include any suitable communication signal input device such as for example a keyboard, microphone, or other device for inputting an electronic or electrical communication signal onto a wire. In some embodiments, a communication signal input device and communication signal receiving device 13 may be connected at more than one end of EL filament 12, so that such two communication signal input devices and communication signal receiving devices 13 may transmit two way communication along EL filament 12.

In an embodiment of the invention, EL filament 12 may be tens or even hundreds of meters long, and for example approximately 5 mm in diameter, with a weight of approximately 40 gram per meter. Other dimensions may be used.

EL filament 12 may include or be connected to an accumulator or power supply such as for example a battery or portable power supply, which may include or be connected to for example an accumulator or power supply with an output voltage of, for example, 12 V and capacity of 3.2 A per hour and driver 17. Other voltages and capacities may be used. In some embodiments, the output signal of driver 17 may have a frequency of for example 700-800 Hz at 100 voltage root means square (VRMS). At such output signal of the driver 17, power supply may provide EL filament 12 with power for operation for 4 hours. Other power sources such as household or emergency current supplies may also be used, and other durations of operation may be achieved.

In operation, such as for example while or after laying out EL filament 12 in an emergency area, some circumstances may favor immediate communication between operators where other communication media are not feasible. Communication signals may be transmitted from one end of EL filament 12 to another using a communication signal input device such as for example a switch that may be located at for example electronic unit 14 and electronic unit 16 and communication signal receiving devices 13 and 15. Communication signal receiving devices 13 and 15 may be used to transmit and relay signals by way of EL filament 12.

Reference is made to FIG. 2, a cross-section of an EL filament 12 with a cylindrical central electrode, in accordance with an embodiment of the invention. Central electrode 22 may be for example a copper or other conducting wire that may be for example 0.5 mm in diameter. Other dimensions may be used. Dielectric reflecting layer 24, electroluminescent layer 26 and transparent conducting layer 28 may be applied concentrically around central electrode 22. Transparent conducting layer 28 may serve as a second electrode to central electrode 22, Dielectric reflecting layer 24 may in some embodiments be or include a polymer binder with a thickness of approximately 25-30 microns. Dielectric reflecting layer 24 may include or be filled with for example barium titanate powder or other suitable dielectric materials. Electroluminescent layer 26 may in some embodiments be or include a polymer binder with a thickness of approximately 45-60 micron and may be filled with a suitable electroluminescent powder. Conducting layer 28 may for example be a sputtered indium tin oxide (ITO) layer that may be approximately 0.05 micron thick. In some embodiments, electroluminescent powder with bluish-green luminescent color may be used, though other colors are possible Adjacent or proximate to the surface of conducting layer 28, there may be situated a metallic wire 44 such as for example a copper wire that may serve as a contact to second electrode on conducting layer 28. Wire 44 may for example be 0.2 mm in diameter. Other dimensions are possible. Wire 44 may be pressed to the surface of conducting layer 28 by for example polymer layer 32 which may be applied by extrusion. Polymer layer 32 may include or be made of for example high modulus polyvinylidene fluoride (PVDF) with a thickness of approximately 0.3 mm to ensure a reliable clamping of wire 44 to the surface of conducting layer 28. Other methods of achieving the adherence of wire 44 to conductive layer 28 are possible. Inside polymer layer 32, a metallic wire 42 such as for example a copper wire that may be coated with for example lacquered insulation may pass along the EL filament 12. Wire 42 may have a diameter of for example 0.1 mm, though other thicknesses may be used. Polymer layer 32 may in some embodiments be coated with or surrounded by for example extruded polyvynil chloride (PVC) layer 34, which may be 1.0 mm thick. In some embodiments, layer 34 may include or be filled with colorant to produce the desires color of EL filament 12 luminescence. A photoluminescent dye with a high quantum output may in some embodiments be used as a colorant. Due to the use of the colorant, the luminescent band may be broadened, to improve its visibility at long distances. On top of layer 34, an external extruded layer 36 may be applied and which may be made of for example a transparent, chemically inert, hydrophobic, non-flammable and firm PVDF. Inside layer 36, there may be included steel wire 46 with the diameter of for example 0.3 mm, and copper wire 48 which may be coated with for example lacquer insulation, 0.1 mm in diameter. Other metallic or conductive materials may be used in such wires and such wires may have other dimensions. The use of PVC between two layers of PVDF may in some embodiments permit increased flexibility and reduced weight for EL filaments 12 with certain diameters.

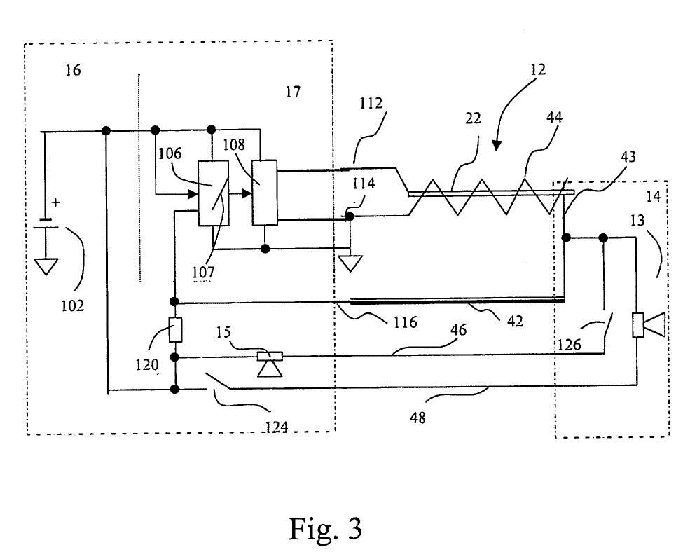

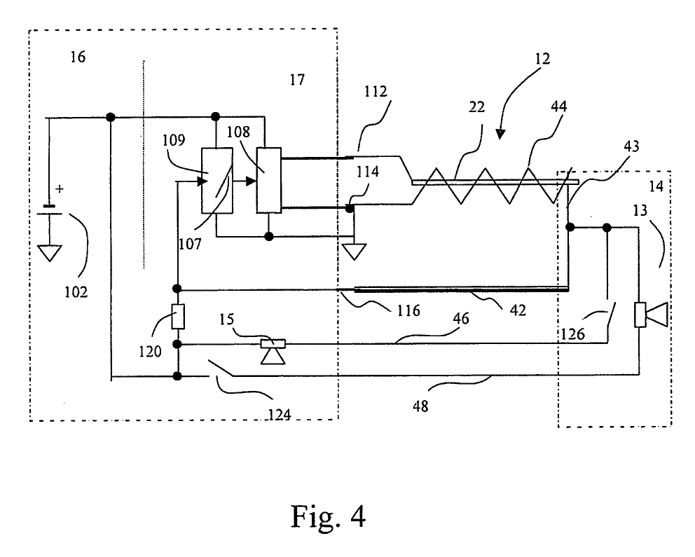

Reference is made to FIG. 3, a schematic electrical diagram of end units connected to an EL filament 12 in accordance with an embodiment of the invention. In some embodiments, electronic unit 16 may include an accumulator or power supply source 102, driver 17, resistor 120, communication signal receiving device 15 and switch 124. Driver 17 may include a two input logic circuit 106 and a generator of sinusoidal voltage oscillations 108. Other components may be included and other configurations of such components are possible.

Electronic unit 14 may include communication signal receiving device 13, switch 126 and electrical connector 43. Connector 43 may connect a grounded wire 44 (contact to for example transparent electrode) with a insulated wire 42.

In operation, some embodiments of the invention may stop a flow of voltage through EL filament 12 in the event that there is a break such as an unexpected break in EL filament 12. Such a break may be caused by for example a heavy object falling on EL filament 12. A stoppage in the flow of voltage through EL filament 12 in the event of a break in EL filament 12 may reduce the risk of sparking, fire, or electrocution that may be caused by such a break in the area of an accident or other emergency. In some embodiments a switch 107 may be used to stop the flow of voltage from a power supply source 102 to EL filament 12 in the event of a break in EL filament 12.

In some embodiments, when EL filament 12 is broken or cut, voltage over EL filament 12 may be stopped, for example, in order to prevent sparking. While different embodiments may use different structures to achieve this result, one embodiment of the present invention may use a two input logic circuit 106. A first input to two input logic circuit 106 may be a voltage supply. A second, controlling input to two input logic circuit 106 may be a grounded wire. Constant positive voltage may be supplied to a first input of two input logic circuit 106 such that voltage reaches the output of the circuit 106 only if the second, controlling input of two input logic circuit 106 is grounded.

In some embodiments, wire 44 may be connected to output 114 of driver 17 Output 114 may be a grounded wire. Additional grounded insulated wire 42 inside electronic unit 14 may be electrically connected to wire 44 by connector 43. The second end of grounded insulated wire 42 may be connected through input 116 of driver 17 with the controllable first input of logic circuit 106, and thus, the controlling input of the circuit 106 is grounded. Positive voltage may be supplied by power supply source 102 through logic circuit 106 to the generator of sinusoidal voltage oscillations 108. Generator of sinusoidal voltage oscillations 108 may generate a sinusoidal signal that may be fed to driver output 112, to central electrode 22, which causes luminescence of EL filament 12. If EL filament 12 is broken or cut, grounded insulated wire 42 will in most cases also be broken. In this case, constant voltage supply from the output of logic circuit 106 to the input of generator of sinusoidal voltage oscillations 108 will be stopped, generator of sinusoidal voltage oscillations 108 will stop generating, and electrode 22 and wire 44 of EL filament 12 will have the same potential, thereby stopping the voltage flow into EL filament 12 and reducing the risk of sparking or electrocution in the event of an unexpected break in EL filament 12. In some embodiments, switch 107 may be part of or operably connected to logic circuit 106.

Communication between the ends of EL filament 12 may in some embodiments be achieved by for example switch 124 and DC circuit comprising communication signal receiving device 13I When the DC circuit including switch 124 is closed, communication signal receiving device 13 may start emitting sound. When switch 126 is closed, communication signal receiving device 15 may emit sound or produce some other signal. Electric circuits of communication signal receiving devices 13 and 15 may in some embodiments comprise multifilament steel wire 46 and metallic wire 44. In some embodiments, such wires may be part of, included in, connected to or proximate to EL filament 12 and may run parallel to EL filament 12. Wire 46 may provide structural support to EL filament 12 which may in some embodiments provide a rupture load to EL filament 12 of 60 kg or more.

Reference is made to FIG. 4, a schematic diagram of end units connected to an EL filament by way of a one input logic unit in accordance with an embodiment of the invention. Unless indicated otherwise, numbered items in FIG. 4 have the same meanings as similarly numbered items in FIG. 3. In some embodiments, one input logic circuit 109 may be connected to grounded insulated wire 42. In the event of a break in grounded insulated wire 42, the voltage from electrode 22 may pass into one input logic circuit 109. Voltage reaching one input logic circuit 109 may close switch 107 thereby stopping the flow of voltage into generator of sinusoidal voltage oscillations 108 and through the rest of filament 12.

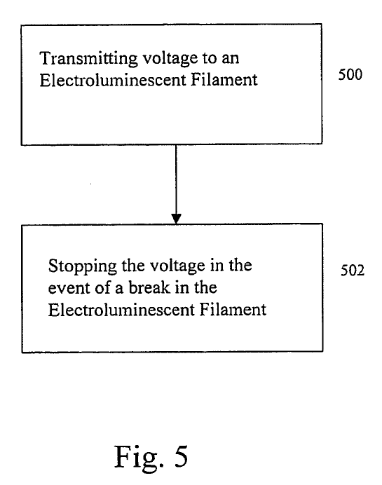

Reference is made to FIG. 5, a flow diagram of a method in accordance with an embodiment of the invention. In block 500 voltage may be transmitted to an EL filament. In some embodiments, such voltage may be transmitted from a portable power source. In block 502, the voltage may be stopped from reaching the EL filament in the event that there is a break in the EL filament. For example, in some embodiments the EL filament may include a switch that may stop the voltage if for example there is a break in a common ground or grounded insulated wire that is included in the EL filament. In some embodiments, such switch may be included in for example a logic circuit.

It will be appreciated by persons skilled in the art that embodiments of the invention are not limited by what has been particularly shown and described hereinabove. Rather the scope of at least one embodiment of the invention is defined by the claims below.

1. A device comprising:
an electroluminescent filament having at least a wire; and
a communication signal input device to transmit an electrical communication signal on said wire.

2. The device as in claim 1, comprising a communication signal receiving device to receive said electrical communication signal.

3. The device as in claim 2, wherein said communication signal receiving device is a buzzer.

4. The device as in claim 2, wherein said communication signal receiving device is a loudspeaker.

5. The device as in claim 1, wherein said communication signal input device comprises an electrical switch.

6. The device as in claim 1, wherein said wire provides structural support to said electroluminescent filament.

7. The device as in claim 1, comprising a portable power supply.

8. The device as in claim 7, wherein said portable power supply provides power to said communication signal input device.

9. The device as in claim 1, comprising at least two communication signal input devices and two communication signal receiving devices to provide two-way communication along said wire.

10. A system comprising:
an electroluminescent filament;
a voltage source; and
a switch to stop voltage over said electroluminescent filament in the event of a break in said electroluminescent filament.

11. The system as in claim 10, comprising:
a two input logic circuit operably connected to said switch wherein a first of said two inputs is connected to a voltage supply to said electroluminescent filament, and a second of said two inputs is connected to a grounded wire;
wherein upon said break in said grounded wire, said voltage supply to said electroluminescent filament stops.

12. The system as in claim 11, comprising a sinusoidal voltage generator.

13. The system as in claim 12, comprising an accumulator to supply said voltage to said sinusoidal voltage generator.

14. The system as in claim 10, comprising a one input logic circuit operably connected to said switch wherein an input in said logic circuit is a common ground.

15. A system comprising:
an electroluminescent filament;
a wire running parallel to said electroluminescent filament;
a communication signal input device to transmit an electrical communication signal on said wire;
a switch to stop voltage over said electroluminescent filament in the event of a break in said electroluminescent filament.

16. The system as in claim 15, comprising:
a two input logic circuit, a first of said two inputs being connected to a voltage supply to said electroluminescent filament, and a second of said two inputs being connected to a grounded second wire;
wherein upon a break in said grounded second wire, said voltage supply to said electroluminescent filament stops.

17. The system as in claim 15, comprising a communication signal receiving device to receive said electrical communication signal.

18. The system as in claim 15, wherein said wire provides structural support to said electroluminescent filament.

19. The system as in claim 15, comprising at least two communication signal input devices and two communication signal receiving devices to provide two-way communication on said wire.

20. The system as in claim 15, wherein said switch in included in a logic circuit, said logic circuit having as an input at least a common ground.

21. A method comprising:
transmitting voltage to an electroluminescent filament; and
stopping voltage through said electroluminescent filament in the event of a break in said electroluminescent filament.

22. The method as in claim 21, wherein said transmitting comprises transmitting said voltage through a two input logic circuit, a first of said two inputs connected to a voltage supply, and a second of said two inputs connected to a grounded wire.

23. The method as in claim 21, comprising transmitting an electrical communication signal along a wire, said wire proximate to and running parallel to said electroluminescent filament.

24. The method as in claim 23, wherein said transmitting comprises transmitting two way communication signals along said wire.

25. The method as in claim 21, wherein said transmitting comprises transmitting said voltage through a logic circuit, said logic circuit having as an input a common ground.
